(19) United States
(12) Patent Application Publication
(10) Pub. No.: US 2022/0357899 A1
(43) Pub. Date: Nov. 10, 2022

(54) IMAGE FORMING APPARATUS CAPABLE OF ALLOCATING MEMORY CAPACITY OF MEMORY AMONG AND DEPENDING ON DIFFERENT TYPES OF PROCESSING CONSTITUTING JOB TO CREATE PLURALITY OF MEMORY REGIONS IN MEMORY

(71) Applicant: KYOCERA Document Solutions Inc., Osaka (JP)

(72) Inventors: Shinya OGAWA, Osaka (JP); Tsuyoshi NITTA, Osaka (JP); Yasuyuki YABUUCHI, Osaka (JP); Satoshi HAYAMA, Osaka (JP); Shinichi HASHIMOTO, Osaka (JP)

(73) Assignee: KYOCERA Document Solutions Inc., Osaka (JP)

(21) Appl. No.: 17/722,730

(22) Filed: Apr. 18, 2022

(30) Foreign Application Priority Data
May 10, 2021 (JP) 2021-079814
May 10, 2021 (JP) 2021-079815

(51) Int. Cl. G06F 3/12

(52) U.S. Cl. CPC G06F 3/1208; G06F 3/1205; G06F 3/1225

(57) ABSTRACT

An image forming apparatus includes a memory, a control device, and an image forming device. The control device includes a processor and functions as a memory manager and a controller through the processor executing a control program. The memory manager allocates amounts of the memory depending on different types of processing constituting a job to create a plurality of memory regions. The controller executes the job using at least one of the plurality of memory regions. The image forming device executes an image forming job of forming an image on a sheet under control of the controller.

### INCORPORATION BY REFERENCE

This application claims priority to Japanese Patent Applications No. 2021-079814 and No. 2021-079815 filed on 10 May 2021, the entire contents of which are incorporated by reference herein.

### BACKGROUND

The present disclosure relates to image forming apparatuses using memories.

Generally, there is known a first technique in which, in an image forming apparatus, the memory capacity of an image memory is allocated among and depending on different roles (reading by a scanner, receipt of data, edition of image data, generation of drawn data, and so on) to create a plurality of memory regions in the image memory. There is also known a second technique in which, in executing a job, a minimum amount of memory necessary to execute the job is reserved.

There is also known a general technique for allocating an amount of memory for use in executing a job. For example, a third technique is known in which, at the startup of an image forming apparatus, the region in a memory included in the image forming apparatus is distributed into an operating system region and an image memory region and, after the startup, the allocation of the memory capacity between both the regions is changed according to a user's instruction. For another example, a fourth technique is known in which, in an image forming apparatus, respective amounts of memory necessary to execute various types of jobs are managed and, for a plurality of jobs being executed, an amount of memory is allocated to each of these jobs based on their past frequencies of execution.

### SUMMARY

A technique improved over the aforementioned techniques is proposed as one aspect of the present disclosure.

An image forming apparatus according to an aspect of the present disclosure includes a memory, a control device, an image forming device. The control device includes a processor and functions as a memory manager and a controller through the processor executing a control program. The memory manager allocates amounts of the memory and depending on different types of processing constituting a job to create a plurality of memory regions. The controller executes the job using at least one of the plurality of memory regions. The image forming device executes an image forming job of forming an image on a sheet under control of the controller.

### BRIEF DESCRIPTION OF THE DRAWINGS

FIG. 1 is a frontal cross-sectional view showing the structure of an image forming apparatus according to a first embodiment of the present disclosure.

FIG. 2 is a functional block diagram schematically showing an essential internal configuration of the image forming apparatus according to the first embodiment of the present disclosure.

FIG. 3A is a view schematically showing memory regions in a memory.

FIG. 3B is a view schematically showing how the allocation of the memory capacity in the memory has been changed.

FIG. 4 is a flowchart showing memory shortage elimination processing.

FIG. 5 is a view showing an example of information stored in a record-of-use storage device.

FIG. 6 is a functional block diagram schematically showing an essential internal configuration of an image forming apparatus according to a second embodiment of the present disclosure.

FIG. 7 is a view showing how the amount of memory to be reserved varies depending on the apparatus state.

FIG. 8 is a view schematically showing how the amount of memory allocated to a memory region has been changed in size.

FIG. 9 is a flowchart showing amount-of-memory change processing.

### DETAILED DESCRIPTION

### First Embodiment

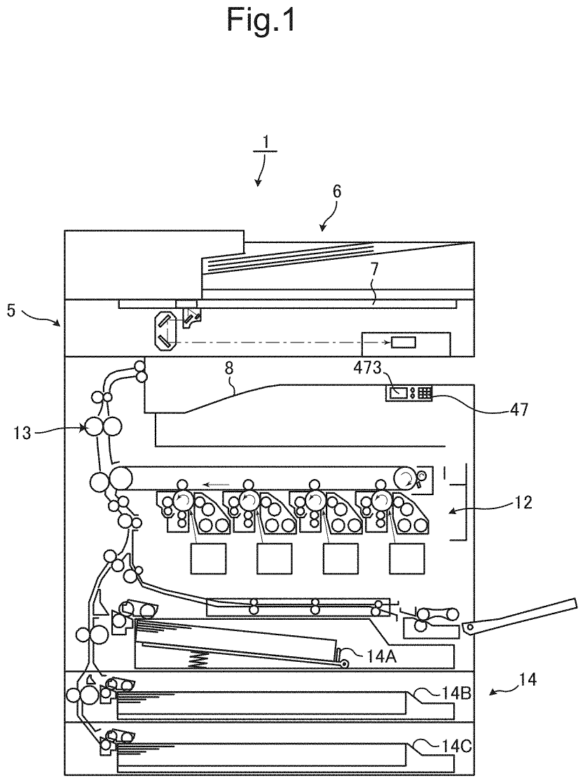

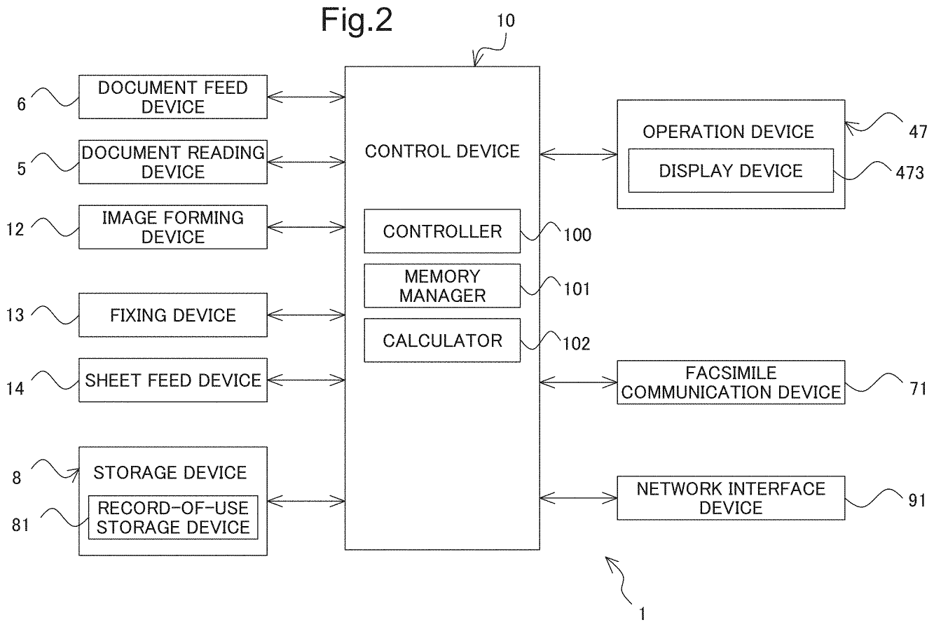

Hereinafter, a description will be given of an image forming apparatus 1 according to a first embodiment of the present disclosure with reference to the drawings. FIG. 1 is a frontal cross-sectional view showing the structure of the image forming apparatus 1 according to the first embodiment of the present disclosure. FIG. 2 is a functional block diagram schematically showing an essential internal configuration of the image forming apparatus 1 according to the first embodiment of the present disclosure. The image forming apparatus 1 is, for example, a multifunction peripheral having multiple functions, such as a copy function, a print function, a scan function, and a facsimile function.

The image forming apparatus 1 includes a control device 10, a document feed device 6, a document reading device 5, an image forming device 12, a fixing device 13, a sheet feed device 14, a storage device 8, an operation device 47, a facsimile communication device 71, and a network interface device 91.

The document feed device 6 is mounted by hinges or the like on the top surface of the document reading device 5 and is thus openable and closable relative to the document reading device 5. The document feed device 6 functions as a document holding cover when the document reading device 5 reads an original document placed on a platen glass 7. The document feed device 6 is an automatic document feed device, such as an ADF (auto document feeder) or a DP (document processor). The document feed device 6 includes a document loading tray and feeds original documents loaded onto the document loading tray to the document reading device 5.

First, a description will be given of the case where a document reading operation is performed on the image forming apparatus 1. The document reading device 5 optically reads an image of an original document fed to the document reading device 5 by the document feed device 6 or an image of an original document placed on the platen glass 7 and generates image data representing the document image. The image data generated by the document reading device 5 is saved in an image memory or the like.

Next, a description will be given of the case where an image forming operation is performed on the image forming apparatus 1. Based on image data generated by the document reading operation, image data received from a computer as an external device connected via a network or another image data, the image forming device 12 forms a toner image on a sheet as a recording medium being fed from the sheet feed device 14.

The fixing device 13 applies heat and pressure to the sheet with the toner image formed thereon by the image forming device 12 to fix the toner image on the sheet. The sheet subjected to the fixation processing is discharged onto a sheet output tray 8. The sheet feed device 14 includes a plurality of sheet feed cassettes 14A to 14C.

The storage device 8 is a large storage device, such as an HDD (hard disk drive) or an SSD (solid state drive). The storage device 8 stores various types of control programs and includes a record-of-use storage device 81. The record-of-use storage device 81 will be described in detail later.

The operation device 47 accepts user's instructions for various types of operations and processing executable by the image forming apparatus 1 (for example, an instruction to execute an image forming job). The operation device 47 includes a display device 473 that displays operation guidance and other types of information for the user. The operation device 47 accepts, through a touch panel provided on the display device 473, a user's instruction based on a user's gesture (for example, a touch gesture) on an operation screen being displayed on the display device 473 or accepts a user's instruction based on a user's operation on a physical key.

The display device 473 is formed of a liquid crystal display (LCD) or the like. The display device 473 is equipped with a touch panel. When the user makes a touch gesture on a button or key being displayed on the screen, the touch panel accepts an instruction associated with a point where the touch gesture has been made.

The facsimile communication device 71 includes a coding/decoding device, a modulation/demodulation device, and an NCU (network control unit). The facsimile communication device 71 performs facsimile communication using a public telephone network or another like network.

The network interface device 91 is a communication interface that performs sending and receiving of various types of data to and from external devices (for example, a personal computer) in a local area or on the Internet.

The control device 10 includes a processor, a RAM (random access memory), a ROM (read only memory), and a dedicated hardware circuit. The processor is, for example, a CPU (central processing unit), an ASIC (application specific integrated circuit) or an MPU (micro processing unit). The above RAM being a constituent of the control device 10 is an example of the memory defined in CLAIMS.

When the processor of the control device 10 operates in accordance with a control program stored in the storage device 8, the control device 10 functions as a controller 100, a memory manager 101, and a calculator 102. However, each of the controller 100 and the other components may not be based on the operation of the control device 10 in accordance with the control program, but may be constituted by a hardware circuit. Hereinafter, the same applies to other embodiments unless otherwise stated.

The controller 100 governs the overall operation control of the image forming apparatus 1. The controller 100 is connected to the document feed device 6, the document reading device 5, the image forming device 12, the fixing device 13, the sheet feed device 14, the storage device 8, the operation device 47, the facsimile communication device 71, and the network interface device 91 and controls the operations and so on of these components. For example, the controller 100 controls the operations of the image forming device 12 and other devices to allow them to execute an image forming job of forming a document image represented by image data obtained by reading of an original document by the document reading device 5 on a sheet as a recording medium.

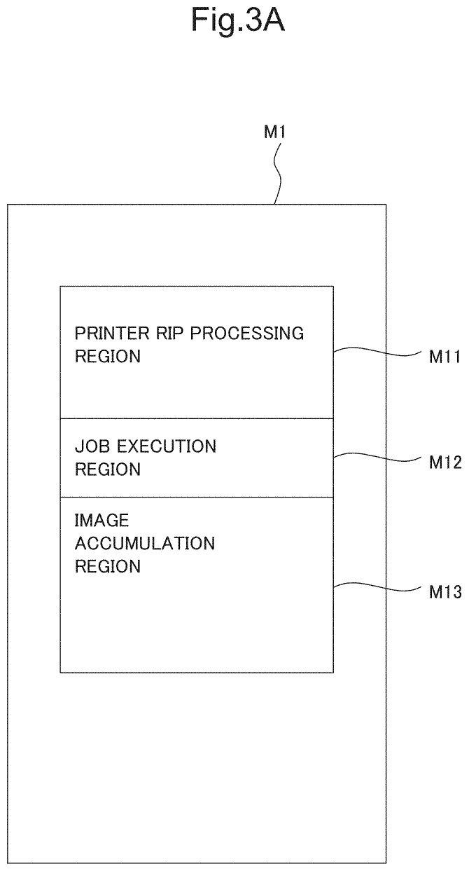

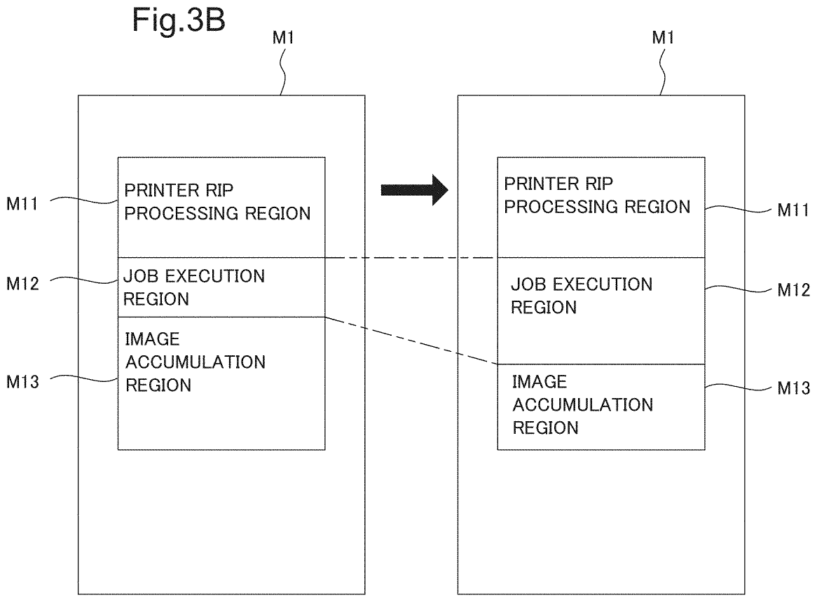

As shown in FIG. 3A, the memory manager 101 allocates the memory capacity of a memory M1 (the RAM described above) among and depending on different types of processing constituting a job to create a plurality of memory regions M11 to M13. In other words, the memory M1 includes the plurality of respective memory regions M11 to M13 associated with the different types of processing. In the first embodiment, the total amount of memory, which is the sum of the respective amounts of memory of the memory regions M11 to M13, is fixed.

The memory region M11 is, for example, a region for use in RIP (raster image processor) processing for converting image data to be printed to a raster image suitable for printing. In other words, the memory region M11 is a “printer RIP processing region”. The memory region M12 is, for example, a workspace for use in the processing of executing a job. In other words, the memory region M12 is a “job execution region”. The memory region M13 is, for example, a region for temporarily holding image data to be printed, processed image data or other image data. In other words, the memory region M13 is an “image accumulation region”.

When the image forming apparatus 1 is in an initial state, the memory manager 101 allocates to the memory regions M11 and M12 respective predetermined minimum amounts of memory necessary to execute their associated types of processing and allocates the remaining amount of memory to the memory region M13.

The controller 100 executes the job using the memory regions M11 to M13 created by the memory manager 101. For example, when accepting a request to execute a copy job, the controller 100 executes the copy job using the memory region M12 as the “job execution region” and the memory region M13 as the “image accumulation region”.

Specifically, the controller 100 reserves from the memory region M13 a region having an amount of memory necessary to temporarily hold image data obtained by reading by the document reading device 5, reserves from the memory region M12 a region having an amount of memory necessary for the processing work of execution of the copy job, and executes the copy job using the reserved regions.

For another example, when accepting a request to execute a print job, the controller 100 executes the print job using not only the memory regions M12 and M13 but also the memory region M11 which is the “printer RIP processing region”.

Upon acceptance of a request to execute a job, the calculator 102 calculates, for each of the memory regions M11 to M13, the amount of memory necessary to execute the job. The amount of memory necessary to execute a job (i.e., the amount of memory consumed by the execution of a job) varies depending on the type of the job and various factors involved in the job. Examples of the factors include, aside from the job type, sheet size, whether to do multicolor printing or black-and-white printing, resolution, file format, the number of pages to be printed, the number of original documents to be read, and printer emulation. The calculator 102 allows, for example, the storage device 8 to previously store, for each job type, the respective basic amounts of memory necessary for respective memory regions to execute the job and the respective amounts of memory necessary for the respective memory regions on a factor-by-factor basis. Generally, as the sheet size increases, the amount of memory consumed increases. Multicolor printing consumes a larger amount of memory than black-and-white printing. The calculator 102 calculates, for each of the memory regions M11 to M13, the amount of memory necessary to execute a job by adding the respective amounts of memory depending on the respective factors involved in the job to be executed to the basic amount of memory depending on the type of the job to be executed.

When the memory manager 101 determines, based on the calculation results of the calculator 102, that the memory regions M11 to M13 include a first memory region unable to reserve the amount of memory necessary to execute a job, the memory manager 101 temporarily frees a partial region of a second memory region not for use to execute the job, the second memory region being one of the memory regions M11 to M13 and different from the first memory region, and temporarily allocates the partial region of the second memory region to the first memory region short of the necessary amount of memory to eliminate the shortage of the necessary amount of memory. In other words, the memory manager 101 allocates the partial region of the second memory region as a memory region for the shortage.

For example, assuming that, in executing a job, the memory region M12 falls short of the necessary amount of memory, but the memory region M13 can make up for the shortage, as shown in FIG. 3B, the memory manager 101 temporarily frees a partial region of the memory region M13 and allocates the freed partial region of the memory region M13 to the memory region M12. Thus, the memory shortage can be eliminated.

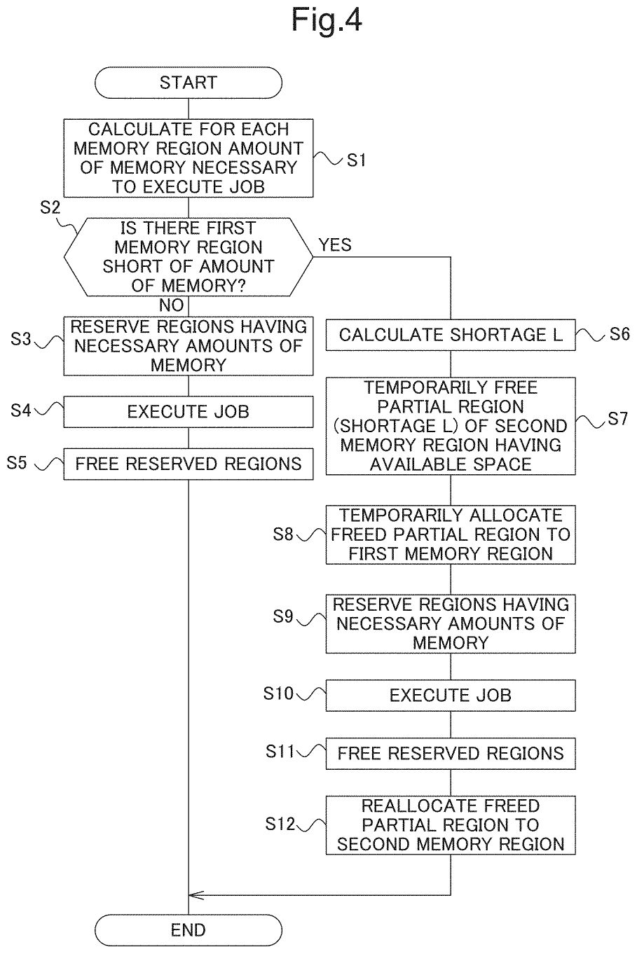

Next, a description will be given of the memory shortage elimination processing as described above, with reference to the flowchart shown in FIG. 4 and so on.

Upon acceptance of a request to execute a job, the calculator 102 calculates, for each of the memory regions M11 to M13, the amount of memory necessary to execute the job (step S1). The memory manager 101 determines, based on how respective amounts of memory are currently allocated to the memory regions M11 to M13, how the memory regions M11 to M13 are currently used, and the calculation results of the calculator 102, whether there is a first memory region unable to reserve the amount of memory necessary to execute the job and thus short of the necessary amount of memory (step S2).

When the memory manager 101 determines that there is no first memory region short of the necessary amount of memory (NO in step S2), the controller 100 reserves, based on the calculation results of the calculator 102, respective regions having the amounts of memory necessary to execute the job in the respective memory regions M11 to M13 (step S3).

The controller 100 executes the job using the reserved regions (step S4). When the execution of the job is completed, the controller 100 frees the regions reserved to execute the job (step S5). After the processing in step S5, the controller 100 ends the memory shortage elimination processing.

On the other hand, when the memory manager 101 determines that there is a first memory region short of the necessary amount of memory (YES in step S2), the memory manager 101 calculates a shortage L of the necessary amount of memory based on how the first memory region is currently used (a currently available amount of memory of the first memory region) and the calculation result of the calculator 102 (i.e., the necessary amount of memory calculated for the first memory region) (step S6).

The memory manager 101 identifies a second memory region that, even when the amount of memory necessary to execute the job calculated by the calculator 102 is reserved, has an available amount of memory equal to or more than the shortage L (i.e., contains a free space having an amount of memory equal to or more than the shortage L), and temporarily frees a partial region (an amount of memory corresponding to the shortage L) of the identified second memory region (step S7). The memory manager 101 temporarily allocates the freed partial region of the second memory region to the first memory region short of the necessary amount of memory (step S8). The controller 100 reserves, based on the calculation results of the calculator 102, respective regions having the amounts of memory necessary to execute to the job from the respective memory regions M11 to M13 after the allocation of the partial region of the second memory region (step S9). The controller 100 restricts the use of the second memory region the partial region of which is freed. For example, the controller 100 does not execute a new job using the second memory region the partial region of which is freed or executes, during execution of a new job, processing using the second memory region only by an amount of memory executable in the second memory region the partial region of which is freed.

The controller 100 executes the job using the respective regions reserved from the memory regions M11 to M13 (step S10). When the execution of the job is completed, the controller 100 frees the regions reserved to execute the job (step S11). The memory manager 101 reallocates to the second memory region the partial region of the second memory region temporarily having been allocated to the first memory region (step S12). In other words, the memory manager 101 restores the memory regions M11 to M13 to previous states before the allocation. After the processing in step S12, the controller 100 ends the memory shortage elimination processing.

In the above first general technique, the image memory can be more effectively used. However, if there arrives a job that requires, in terms of each memory region, an amount of memory exceeding the allocated amount of memory, a memory shortage occurs, which makes it difficult to appropriately execute the job. The above second general technique is not a technique for creating a plurality of memory regions in a memory.

Unlike the above general techniques, in the first embodiment, when there is a first memory region unable to reserve the amount of memory necessary to execute a job and thus falling short of the necessary amount of memory, a partial region of a second memory region different from the first memory region is temporarily accommodated, which eliminates the memory shortage. Therefore, the memory can be adjusted according to how the memory is actually used and the allocation of the amounts of memory can be optimized. As a result, the image forming apparatus 1 can be prevented from decreasing its performance due to memory shortage.

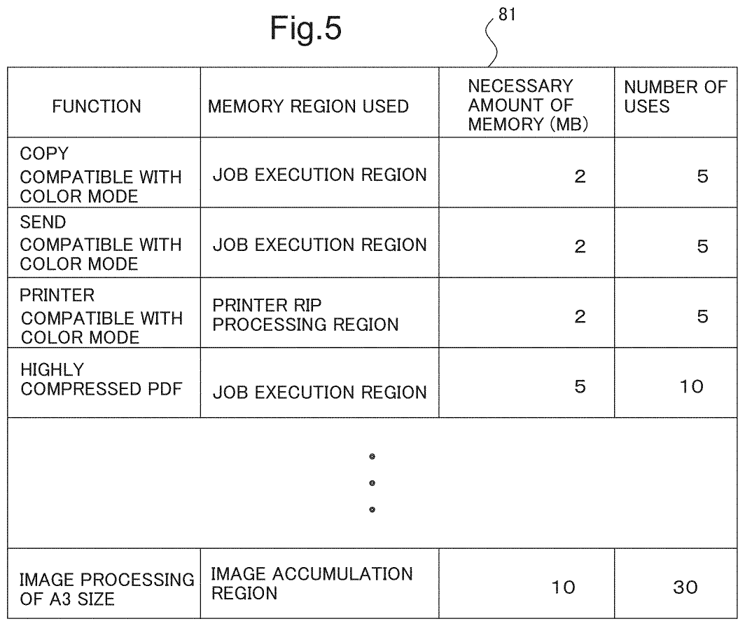

Next, a description will be given of the record-of-use storage device 81 included in the storage device 8. The record-of-use storage device 81 stores respective past records of use of the memory regions M11 to M13. As shown in FIG. 5, the record-of-use storage device 81 stores, in association with each function, the memory region used, the amount of memory necessary to realize the function, and the number of uses of the memory region for realizing the function.

When any one of the memory regions M11 to M13 is used, the controller 100 updates, based on how the memory region is used, the above information stored in the record-of-use storage device 81. For example, in executing a job of “multicolor copying onto A3-size sheet”, the controller 100 uses the function “Copy Compatible with Color Mode” and the function “Image Processing of A3 Size”. Therefore, the controller 100 counts up the respective numbers of uses associated with these functions to update the information stored in the record-of-use storage device 81.

The memory manager 101 changes, based on the respective past records of use of the memory region M11 to M13, the allocation of their respective amounts of memory in the memory M1 depending on different types of processing. For example, when, immediately after the power-on of the image forming apparatus 1 or immediately after the return thereof from a sleep mode, the memory manager 101 determines, with reference to the information (past records of use) stored in the record-of-use storage device 81, that the frequency of use of a function exceeds a predetermined threshold, the memory manager 101 adds an amount of memory necessary to realize the function to the memory region to be used for the function. In other words, the allocation of amounts of memory among the memory regions M11 to M13 is changed and the memory regions M11 to M13 are reorganized into a changed state. Thus, the allocation can be adjusted according to how the memory M1 is actually used, and the amounts of memory can be more optimally allocated than ever before.

For example, when the number of uses of the function “Copy Compatible with Color Mode” exceeds the above threshold, the memory manager 101 frees a partial region having an amount of memory of “2 MB” in the memory region M13 which is the “image accumulation region” and adds the freed region to the memory region M12 which is the “job execution region”.

The reason why the memory manager 101 frees not a partial region of the memory region M11, but a partial region of the memory region M13 is that the amount of memory allocated to each of the memory regions M11 and M12 in an initial state of the image forming apparatus 1 is only a minimum amount of memory necessary to execute processing associated with the memory region M11 or M12 and the remaining amount of memory is allocated to the memory region M13.

Alternatively, in the initial state of the image forming apparatus 1, the memory manager 101 may allocate to each of the memory regions M11 and M12 a maximum amount of memory necessary to execute the processing associated with the memory region M11 or M12 and allocate the remaining amount of memory to the memory region M13. In this case, when determining that the frequency of use of a function is lower than a predetermined threshold, the memory manager 101 frees, of the memory region for use in realizing the function, a partial region having an amount of memory necessary to realize the function.

Since, as thus far described, the allocation of respective amounts of memory to the memory regions M11 to M13 is changed based on the past records of use of the memory regions M11 to M13, the allocation of the amounts of memory can be further optimized. Thus, in executing a job, the allocation of amounts of memory in the memory regions M11 to M13 among different types of processing necessary to execute the job can be well balanced, which increases the performance.

As a result of optimization of the allocation of amounts of memory, another first memory region falling short of the necessary amount of memory may appear. However, in this case, an amount of memory is temporarily allocated to the first memory region from a second memory region different from the first memory region to eliminate the memory shortage, which enables prevention of a performance degradation due to the memory shortage.

For example, when the frequency of use of the function “Highly Compressed PDF” is low, the amount of memory corresponding to the function is freed from the memory region M12. When, in this state, a “Send” job using the memory region M12 arrives, a memory shortage may occur.

When determining, upon arrival of a “Send” job, that the memory region M12 is short of the necessary amount of memory, the memory manager 101 temporarily frees a partial region of the memory region M11 because of non-use of the memory region M11 in the “Send” job and allocates the partial region of the memory region M11 to the memory region M12. In doing so, the controller 100 restricts the use of the memory region M12 the partial region of which has been freed. The controller 100 restricts a print job, for example, by rejecting the acceptance of a new print job.

For another example, when determining, upon arrival of a “print job”, that the memory region M11 is short of the necessary amount of memory, the memory manager 101 temporarily frees a partial region of the memory region M13 and allocates the partial region of the memory region M13 to the memory region M11. In this case, the controller 100 restricts the use of the memory region M13, for example, by decreasing the number of readable pages.

### Second Embodiment

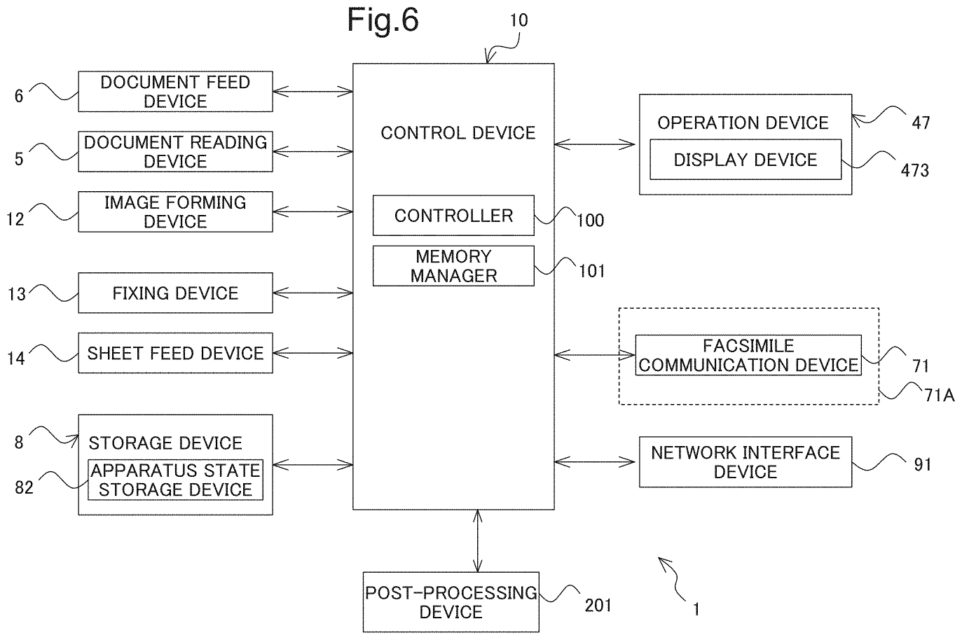

Hereinafter, a description will be given of an image forming apparatus 1 according to a second embodiment of the present disclosure with reference to the drawings. FIG. 6 is a functional block diagram schematically showing an essential internal configuration of the image forming apparatus 1 according to the second embodiment of the present disclosure. The image forming apparatus 1 according to the second embodiment has the same configuration as the image forming apparatus 1 according to the first embodiment, except that the storage device 8 includes, instead of the record-of-use storage device 81, an apparatus state storage device 82 and the control device 10 does not function as the calculator 102. The following description is given of differences from the image forming apparatus 1 according to the first embodiment.

The storage device 8 includes an apparatus state storage device 82 that stores information indicating the apparatus state of the image forming apparatus 1.

When the processor of the control device 10 operates in accordance with a control program stored in the storage device 8, the control device 10 functions as the controller 100 and the memory manager 101.

The document feed device 6 is detachably mounted to the image forming apparatus 1. When the document feed device 6 is unmounted, a simple document holding cover is mounted, instead of the document feed device 6, to the image forming apparatus 1.

In the initial state of the image forming apparatus 1, the memory manager 101 allocates to each of the memory regions M11 to M13 a maximum amount of memory within a possible range. In the second embodiment, the total amount of memory, which is the sum of the respective amounts of memory of the memory regions M11 to M13, is not fixed.

The memory manager 101 changes, based on the apparatus state of the image forming apparatus 1, the size of the amounts of memory to be allocated to the memory regions M11 to M13.

For example, the memory manager 101 determines as the apparatus state whether or not the document feed device 6, which is an automatic document feed device, is mounted to the image forming apparatus 1, and changes, based on the determination result, the size of the amount of memory to be allocated to the memory region M13. Specifically, when the document feed device 6 is mounted to the image forming apparatus 1, it is necessary to secure a state where the document reading device 5 can continuously read a large amount of original documents. Therefore, a large amount of memory needs to be allocated to the memory region M13 which is the “image accumulation region” in order to temporarily store therein image data representing document images obtained by reading of the original documents by the document reading device 5. For example, the memory manager 101 allocates, to the memory region M13 serving as a region for storing image data, an amount of memory capable of storing image data of 200 pages.

On the other hand, when the document feed device 6 is not mounted to the image forming apparatus 1, the document reading device 5 needs to read original documents placed sheet by sheet on the platen glass 7 by the user, in which case it can be considered that the amount of original documents to be continuously read by the document reading device 5 at once is relatively small. Therefore, when the document feed device 6 is not mounted to the image forming apparatus 1, a less amount of memory needs to be allocated to the memory region M13 serving as the region for storing image data than when the document feed device 6 is mounted to the image forming apparatus 1. For example, the memory manager 101 is sufficient to allocate, to the memory region M13 serving as the region for storing image data, an amount of memory capable of storing image data of a number of pages (for example, 50 pages) smaller than 200.

To sum up, when the document feed device 6 is not mounted to the image forming apparatus 1, the amount of memory to be allocated to the memory region M13 may be smaller than when the document feed device 6 is mounted to the image forming apparatus 1. However, generally, the amount of memory is not allocated in consideration of whether or not the document feed device 6 is mounted to the image forming apparatus 1.

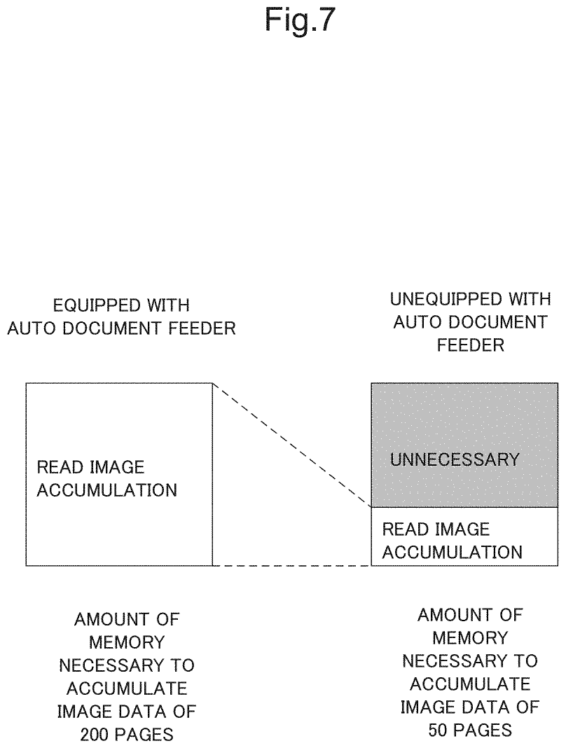

FIG. 7 is a view showing how the amount of memory to be reserved varies depending on the apparatus state. As shown in FIG. 7, when the document feed device 6, which is an automatic document feed device, is mounted to the image forming apparatus 1, it is necessary to reserve an amount of memory corresponding to image data of 200 pages as a region necessary to accumulate image data. On the other hand, when the document feed device 6 is not mounted to the image forming apparatus 1, it is sufficient to reserve an amount of memory corresponding to image data of 50 pages.

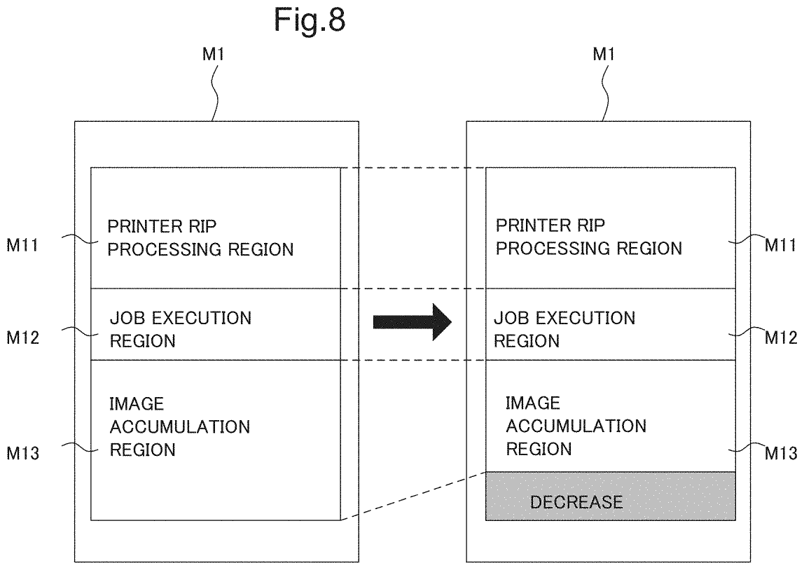

Therefore, when determining that the document feed device 6 is not mounted to the image forming apparatus 1, the memory manager 101 decreases the amount of memory of the memory region M13 by “an amount of memory necessary to accumulate image data of 150 pages” and frees the decrease as a shared memory usable for other types of processing as shown in FIG. 8.

FIG. 8 is a view schematically showing how the amount of memory allocated to the memory region M13 has been changed in size. The left-hand portion of the figure shows a state before the amount of memory is decreased, while the right-hand portion of the figure shows a state after the amount of memory is decreased.

If there arises the need to accumulate image data exceeding an expected number of pages (50 pages in this case) into the memory region M13, the memory manager 101 may additionally allocate from the shared memory an amount of memory specified by a user's specification input by an operation on the operation device 47.

As described above, when the document feed device 6 is not mounted to the image forming apparatus 1, the amount of memory to be allocated to the memory region M13 which is the “image accumulation region” may be decreased as shown in FIG. 7. Likewise, when the apparatus state is in the following cases, the size of the amounts of memory to be allocated to the memory regions M11 to M13 may be decreased.

<Sheet Size>

As the sheet size increases, the size of an image formed on a sheet increases, which increases the necessary amount of memory. On the contrary, as the sheet size decreases, the necessary amount of memory decreases. Therefore, when the size of sheets loaded into the sheet feed cassettes 14A to 14C is small, the amount of memory to be reserved in the memory region M13 can be made small. In view of this, the memory manager 101 determines as the apparatus state the size of sheets loaded into the sheet feed cassettes 14A to 14C and changes, according to the sheet size, the size of the amount of memory to be allocated to the memory region M13.

<Failure Isolation>

In the image forming apparatus 1, a system is established in which even if a predetermined failure occurs, instead of a complete shutdown of the whole apparatus, a mechanism (function) that will be affected by the failure is restricted in operation and other mechanisms that will not be affected by the failure are allowed to operate. This is a so-called “failure isolation”.

If in this image forming apparatus 1 the predetermined failure occurs, there is a function not operating and being disabled. Because no amount of memory needs to be reserved for the disabled function, the memory manager 101 can decrease, in the presence of the predetermined failure, the amount of memory to be reserved to a smaller size than in the absence of the predetermined failure. In view of this, the memory manager 101 determines as the apparatus state whether or not the predetermined failure occurs, and, in the presence of the predetermined failure, decreases the amounts of memory to be allocated to the memory regions M11 to M13 to a smaller size than in the absence of the predetermined failure.

<Extension Board>

The image forming apparatus 1 is configured to be capable of being additionally equipped with an extension board. For example, a facsimile function can be added to the image forming apparatus 1 by equipping the image forming apparatus 1 with a facsimile extension board 71A.

When a facsimile function is added, there arises the need to reserve an amount of memory for the facsimile function. However, when the facsimile function is not added, there is no need to reserve an amount of memory for the facsimile function. Therefore, when the image forming apparatus 1 is not equipped with a predetermined extension board, the amount of memory to be reserved can be decreased to a smaller size than when the image forming apparatus 1 is equipped with the extension board. In view of this, the memory manager 101 determines as the apparatus state whether or not the image forming apparatus 1 is equipped with any extension board, and, in the absence of the extension board, decreases the amounts of memory to be allocated to the memory regions M11 to M13 to a smaller size than in the presence of the extension board.

<Post-Processing Device 201>

The image forming apparatus 1 is configured to be capable of being equipped with a post-processing device 201 that subjects a sheet with an image formed thereon to post-processing (for example, sorting or punching).

When the image forming apparatus 1 is equipped with the post-processing device 201, the function therefor is added, which needs to reserve an amount of memory for the added function. However, when the image forming apparatus 1 is not equipped with the post-processing device 201, there is no need to reserve the amount of memory therefor. Therefore, when the image forming apparatus 1 is not equipped with the post-processing device 201, the amount of memory to be reserved can be decreased to a smaller size than when the image forming apparatus 1 is equipped with the post-processing device 201. In view of this, the memory manager 101 determines as the apparatus state whether or not the image forming apparatus 1 is equipped with the post-processing device 201, and, in the absence of the post-processing device 201, decrease the amounts of memory to be allocated to the memory regions M11 to M13 to a smaller size than in the presence of the post-processing device 201.

<Application Software>

When any application software is turned on, the function therefor is added, which needs to reserve an amount of memory for the added function. However, when the application software is turned off, there is no need to reserve the amount of memory therefor. Therefore, when predetermined application software is turned off, the amount of memory to be reserved can be decreased to a smaller size than when the application software is turned on. In view of this, the memory manager 101 determines, as the apparatus state, whether or not predetermined application software is enabled, and, in the case of the application software being disabled, decreases the amounts of memory to be allocated to the memory regions M11 to M13 to a smaller size than in the case of the application software being enabled.

As for the above apparatus states, the controller 100 monitors them and allows the apparatus state storage device 82 to store information on each of the apparatus states. Thus, the memory manager 101 recognizes the apparatus states by referring to the information stored in the apparatus state storage device 82.

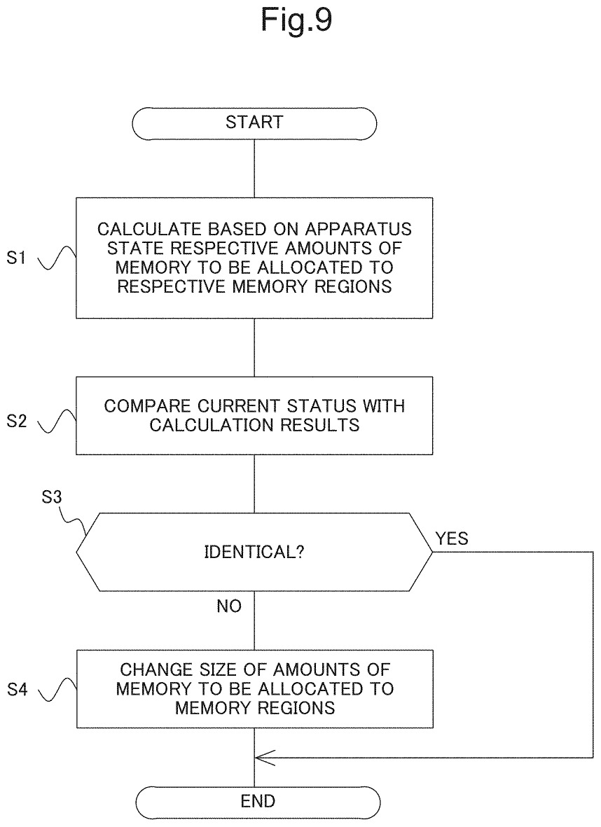

Next, a description will be given of amount-of-memory change processing for changing the amounts of memory to be allocated to the memory regions M11 to M13 as described above, with reference to the flowchart shown in FIG. 9 and so on. The time to execute the amount-of-memory change processing is immediately after the power-on of the image forming apparatus 1 or immediately after the return thereof from the sleep mode.

The memory manager 101 calculates, based on the information stored in the apparatus state storage device 82, the respective amounts of memory to be allocated to the respective memory regions M11 to M13 (step S1). The memory manager 101 compares how respective amounts of memory are currently allocated to the memory regions M11 to M13 with the above calculation results (step S2) and determines whether or not the former is identical with the latter (step S3).

When determining that the former is identical with the latter (YES in step S3), the memory manager 101 ends the amount-of-memory change processing. On the other hand, when determining that the former is not identical with the latter (NO in step S3), the memory manager 101 changes, based on the calculation results, the size of the amounts of memory to be allocated to the memory regions M11 to M13 (step S4). After the processing in step S4, the memory manager 101 ends the amount-of-memory change processing.

For example, when the size of sheets loaded into the sheet feed cassettes 14A to 14C is changed from A3 size to A4 size, the memory manager 101 calculates the amount of memory necessary for A4 size and frees a decrease in the amount of memory as a shared memory. On the other hand, when the size of sheets loaded into the sheet feed cassettes 14A to 14C is changed from A4 size to A3 size, the memory manager 101 calculates the amount of memory necessary for A3 size and makes up for an increase in the amount of memory with the shared memory.

In the above third general technique, setting by the user is necessary to change the allocation of the amounts of memory, which is a troublesome work and a burden on the user. The above fourth general technique is not a technique for creating a plurality of memory regions in a memory.

Unlike the above general techniques, since in the second embodiment the size of the amounts of memory to be allocated to the memory regions is changed based on the apparatus state, it is possible to optimize the allocation of memory according to the state of the image forming apparatus 1 without imposing any burden on the user. In addition, since the size of the amounts of memory to be allocated to the memory regions is changed based on the apparatus state, an excessive memory allocation can be prevented and the memory can be more effectively used.

Although in the second embodiment the memory manager 101 changes the amount of memory after checking the apparatus state immediately after the power-on of the image forming apparatus 1 or immediately after the return thereof from the sleep mode, the timing for the change in amount of memory is not limited to the timing described in the second embodiment. For example, the memory manager 101 may change the amount of memory with the timing when the controller 100 has confirmed a change in the apparatus state.

The present disclosure is not limited to the above embodiments and can be modified in various ways. Although in the above embodiments a multifunction peripheral is used as an embodiment of the image forming apparatus according to the present disclosure, the multifunction peripheral is merely illustrative and, for example, other image forming apparatuses having a copy function or a print function may be used.

The structures, configurations, and processing of the embodiments described with reference to FIGS. 1 to 9 are merely illustrative and are not intended to limit the present disclosure to them.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
a memory;
a control device including a processor and functioning, through the processor executing a control program, as (i) a memory manager that allocates amounts of the memory depending on different types of processing constituting a job to create a plurality of memory regions and (ii) a controller that executes the job using at least one of the plurality of memory regions; and
an image forming device that executes an image forming job of forming an image on a sheet under control of the controller.

2. The image forming apparatus according to claim 1, wherein
the control device further functions as a calculator that calculates, when accepting a request to execute the job, respective amounts of memory necessary to execute the job for respective memory regions, and
when the plurality of memory regions include a first memory region unable to reserve an amount of memory which is necessary to execute the job and has been calculated by the calculator, the memory manager temporarily frees a partial region, which is not for use to execute the job, of a second memory region which is one of the plurality of memory regions and different from the first memory region, and temporarily allocates the partial region of the second memory region to the first memory region short of the necessary amount of memory.

3. The image forming apparatus according to claim 2, wherein the controller restricts use of the second memory region the partial region of which is freed.

4. The image forming apparatus according to claim 2, wherein the memory manager changes allocation of the respective amounts of memory to the plurality of memory regions based on respective past records of use of the plurality of memory regions.

5. The image forming apparatus according to claim 2, wherein the memory manager calculates a shortage of the necessary amount of memory in the first memory region based on an available amount of memory of the first memory region and the calculated necessary amount of memory of the first memory region, and identifies, as the second memory region, one of the plurality of memory regions that contains a free space having an amount of memory equal to or more than the shortage even with the necessary amount of memory reserved.

6. The image forming apparatus according to claim 1, wherein the memory manager changes a size of the amount of memory to be allocated to a memory region, based on an apparatus state of the image forming apparatus.

7. The image forming apparatus according to claim 6, wherein, in decreasing the amount of memory to be allocated to the memory region, the memory manager frees the decreased amount of memory as a shared memory usable for other types of processing.

8. The image forming apparatus according to claim 6, further comprising:
a document reading device that reads an image of an original document and generates image data from the read image; and
an automatic document feed device capable of being detachably mounted to the image forming apparatus,
wherein the memory manager determines, as the apparatus state, whether or not the automatic document feed device is mounted to the image forming apparatus, and
when the automatic document feed device is unmounted to the image forming apparatus, the memory manager decreases the amount of memory to be allocated to the memory region for image accumulation to a smaller size than when the automatic document feed device is mounted to the image forming apparatus.

9. The image forming apparatus according to claim 6,
further comprising a sheet feed cassette into which one or more sheets are loaded,
wherein the memory manager determines, as the apparatus state, a size of the one or more sheets loaded into the sheet feed cassette and changes, depending on the size of the one or more sheets, the size of the amount of memory to be allocated to the memory region for image accumulation.

10. The image forming apparatus according to claim 6, wherein the memory manager determines, as the apparatus state, whether or not a predetermined failure occurs in the image forming apparatus, and, in the presence of the predetermined failure, decreases the amount of memory to be allocated to the memory region to a smaller size than in the absence of the predetermined failure.

11. The image forming apparatus according to claim 6, wherein
the image forming apparatus is capable of being equipped with a predetermined extension board,
the memory manager determines, as the apparatus state, whether or not the image forming apparatus is equipped with the extension board, and,
when the image forming apparatus is unequipped with the extension board, the memory manager decreases the amount of memory to be allocated to the memory region to a smaller size than when the image forming apparatus is equipped with the extension board.

12. The image forming apparatus according to claim 6, wherein
the image forming apparatus is capable of being equipped with a post-processing device that subjects the sheet with the image formed thereon by the image forming device to post-processing,
the memory manager determines, as the apparatus state, whether or not the image forming apparatus is equipped with the post-processing device, and,
when the image forming apparatus is unequipped with the post-processing device, the memory manager decreases the amount of memory to be allocated to the memory region to a smaller size than when the image forming apparatus is equipped with the post-processing device.

13. The image forming apparatus according to claim 6, wherein
the memory manager determines, as the apparatus state, whether or not predetermined application software is enabled, and,
when the application software is disabled, the memory manager decreases the amount of memory to be allocated to the memory region to a smaller size than when the application software is enabled.

14. The image forming apparatus according to claim 6, wherein the memory manager changes the size of the amount of memory immediately after power-on of the image forming apparatus or immediately after return of the image forming apparatus from a sleep mode.
